(19) United States
(12) Patent Application Publication
(10) Pub. No.: US 2017/0210057 A1
(43) Pub. Date: Jul. 27, 2017

(54) BELT SPLICER AND METHOD OF SPLICING

(71) Applicant: MOL BELTING COMPANY, Grand Rapids, MI (US)

(72) Inventors: Tave Hass, Allendale, MI (US); Michael DeGroot, Grand Rapids, MI (US)

(73) Assignee: MOL BELTING COMPANY, Grand Rapids, MI (US)

(21) Appl. No.: 15/500,324

(22) PCT Filed: Feb. 15, 2016
(86) PCT No.: PCT/US16/17934

§ 371 Date: Jan. 30, 2017

Related U.S. Application Data
(60) Provisional application No. 62/116,908, filed on Feb. 16, 2015.

(51) Int. Cl. B29C 65/14; B29D 29/06; B29C 65/78; B29C 65/00; B29C 65/20; B29C 65/30

(52) U.S. Cl. CPC B29C 65/1432; B29C 65/2076; B29C 65/305; B29C 65/7802; B29C 65/7841; B29C 66/1142; B29C 66/4324; B29C 66/73921; B29C 66/855; B29C 66/91231; B29D 29/06; B29L 2031/709

(57) ABSTRACT

A belt splicer includes a pair of decks, each configured to hold a belt end. At least one of the decks is movable along a direction perpendicular to the longitudinal axes of the belt ends to impart a shearing force at the at least partially molten interface between the belt ends. The movement of at least one of the at least partially molten mating edges generally parallel to the interface facilitates formation of an improved joint between the belt ends.

### CROSS-REFERENCE TO RELATED APPLICATION

This application claims the benefit of U.S. Provisional Patent Application No. 62/116,908, filed on Feb. 16, 2015, which is incorporated herein in its entirety.

### BACKGROUND

Conveyor belts are commonly used in the transportation of loads from one location to another location in various industries. The particular type of belt employed depends on the particular application, and examples of conveyor belts include multilayered belts and reinforced or unreinforced monolithic belts. During installation and repair of conveyor belts, the ends of one or more belts are typically joined together, and one method of joining belts is splicing the belt ends with welding. The process involves heating the belt ends to at least a partially molten state and simultaneously or subsequently moving the belt ends together in a direction perpendicular to the belt longitudinal axis until the belt ends abut one another, thus allowing the molten material of the belt ends to intermix and harden to form a joint.

### BRIEF SUMMARY

In one aspect, a belt splicer for splicing two ends of at least one thermoplastic belt together includes a first elongated deck configured to hold a first end of one or more thermoplastic belts, and a second elongated deck configured to hold a second end of the thermoplastic belts in the same plane as the first end, where the first and second elongated decks having parallel longitudinal axes. A sliding assembly is coupled to the first and second elongated decks to urge at least one of them in a sliding direction toward or away from the other. A shifting assembly is coupled to one of the first and second elongated decks to urge at least one of them a shifting direction adjacent one another. A heating element is disposed to heat the first and second ends to a melt temperature. The sliding assembly and the shifting assembly move the first and second elongated decks in the sliding and shifting directions to splice the first and second ends together after the first and second ends are heated to the melt temperature.

In another aspect, a method of splicing two ends of one thermoplastic belts together includes positioning a first end of a thermoplastic belt spaced apart from a second end of thermoplastic belt in the same plane as the first end, heating the first and second ends to a softened state, sliding at least one of the first and second ends toward the other of the first and second ends, and shifting the first and second ends relative to each other as the first and second ends meet while the first and second ends are in the softened state.

### BRIEF DESCRIPTION OF THE DRAWINGS

In the drawings:

FIG. 1 is a perspective view of a belt splicer according to one embodiment, with a sliding deck and a shifting deck in opened and shifted positions, respectively.

FIG. 2 is a perspective view of a clamping assembly for the belt splicer of FIG. 1, including clamp levers, one of which is shown inset as exploded, in an unclamped position.

FIG. 3 is a perspective view similar to FIG. 2 with the clamp levers in a clamped position.

FIG. 4 is a bottom perspective view of the belt splicer of FIG. 1, with a base of the belt splicer removed for viewing the interior components of the belt splicer.

FIG. 5 is a perspective view of a heating element positioner from the belt splicer of FIG. 1, schematically showing the relationship between the positioner, a heating element, a thermocouple, a temperature controller, and a switch activated by the positioner.

FIG. 6 is a bottom view of one end of the belt splicer of FIG. 1.

FIG. 7 is a perspective view of a cross-section taken along line VII-VII of FIG. 6.

FIG. 8 is a perspective view of a sliding assembly from the belt splicer of FIG. 1.

FIG. 9 is a perspective view of a cross-section taken along line IX-IX of FIG. 6, with the sliding deck the opened position.

FIG. 10 is a cross-sectional view taken along line X-X of FIG. 9.

FIG. 11 is a cross-sectional view similar to FIG. 9, with the sliding deck in a closed position.

FIG. 12 is a bottom view of one end of the belt splicer of FIG. 1, specifically the end opposite the end shown in FIG. 6.

FIG. 13 is a perspective view of a shifting assembly of the belt splicer of FIG. 1.

FIG. 14 is a top view of the end of the belt splicer shown in FIG. 12, with the sliding and shifting decks removed but outlined in phantom and the clamping assemblies and clamp levers removed.

FIG. 15 is a bottom perspective view of the end of the belt splicer shown in FIG. 12.

FIGS. 16A-16D are schematic views showing positions of the shifting assembly as the sliding deck moves between the closed and opened positions.

FIG. 17 is a top view of the end of the belt splicer shown in FIG. 12, with the clamping assembly for the shifting deck removed for clarity of viewing the shifting deck in the shifted position.

FIG. 18 is a top view similar to FIG. 17, with the shifting deck in an aligned position.

FIG. 19 is a perspective view of the belt splicer similar to FIG. 1, with the sliding deck and the shifting deck in the closed and aligned positions, respectively.

FIGS. 20A-20H are schematic views showing positions of the sliding and shifting decks, along with belt ends carried by the decks, during operation of the belt splicer of FIG. 1.

FIGS. 21A-21D are schematic views showing positions of an alternative shifting assembly as the sliding deck moves between the closed and opened positions.

FIG. 22 is a perspective view of a belt trimming jig according to one embodiment.

FIG. 23 is a bottom perspective view of the belt trimming jig of FIG. 22.

FIG. 24 is an enlarged perspective view of an end of the belt trimming jig of FIG. 22.

### DETAILED DESCRIPTION

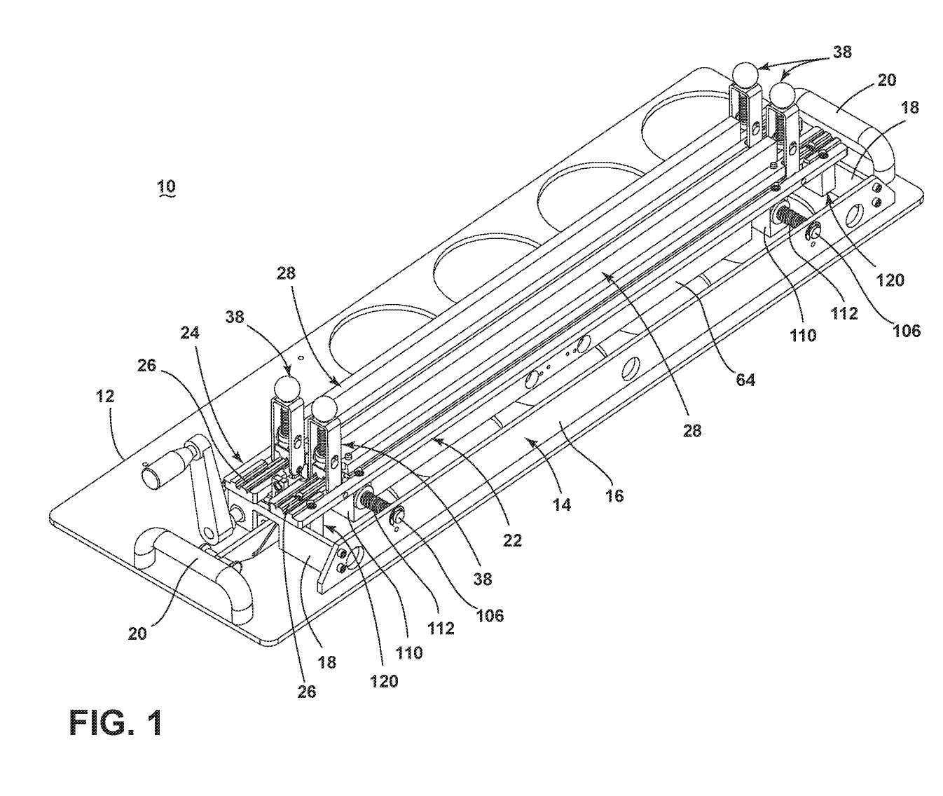

FIG. 1 illustrates a belt splicer 10 according to a first embodiment for welding ends of two belts, such as conveyor belts, together to form a single belt. The belt splicer 10 is supported by a generally planar base 12 and a frame 14 mounted to the base 12 and formed by a pair of opposing side walls 16 spaced apart and connected by a pair of end walls 18 generally transverse to the side walls 16. A pair of handles 20 near the side edges of the base 12 facilitates transport of the splicer 10. Two elongated decks, a sliding deck 22 and a shifting deck 24, both movably mounted to the frame 14 in parallel arrangement relative to each other and to the frame side walls 16, each include a corrugated upper surface 26 to accommodate conveyor belt teeth, as is known in the art, and a clamping assembly 28 vertically movable relative to the deck upper surface 26 for selectively clamping a conveyor belt end between the clamping assembly 28 and the deck upper surface 26.

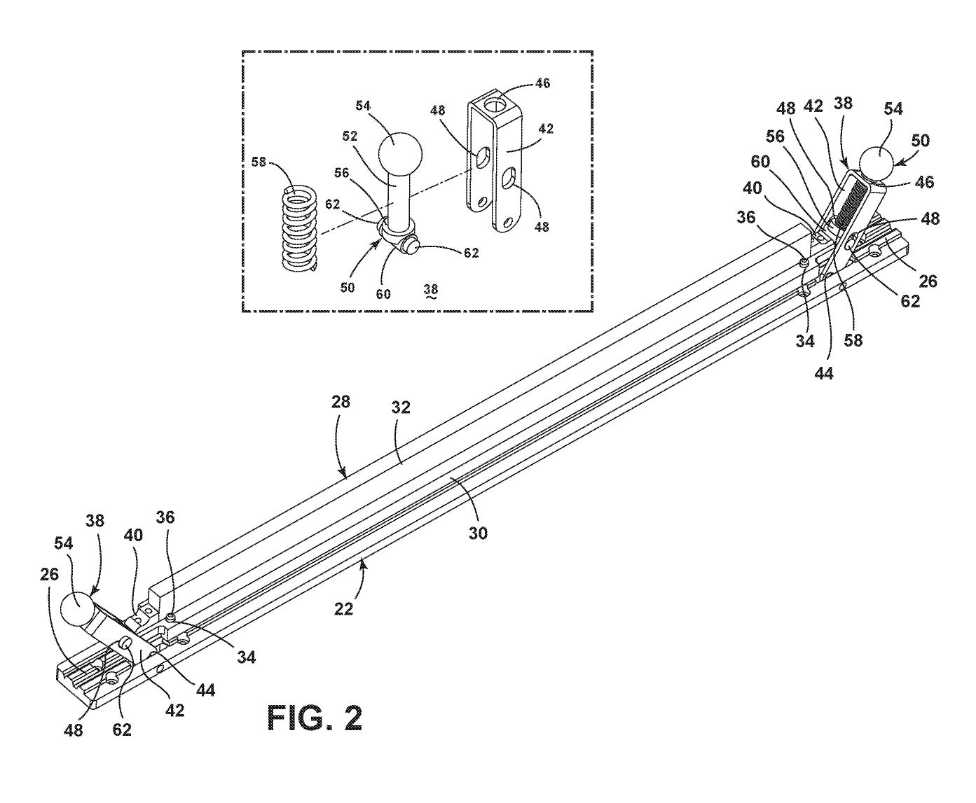

FIG. 2 is a perspective view of the sliding deck 22 and its corresponding clamping assembly 28. The clamping assembly 28 includes an elongated clamp base 30 mounted to a clamp body 32 extending upwardly from the clamp base 30. A pair of apertures 34 formed near the ends of the clamp base 30 slidingly receive dowels 36 extending upward from the deck 22 to slidingly couple the clamp base 30 to the deck 22. Both ends of the clamp base 30 narrow for receipt within a clamp lever 38 and support a contoured cam seat 40 on an upper surface thereof adjacent the ends of the clamp body 32. The overall length of the clamping assembly 28 is shorter than that of the deck 22. When the clamp levers 38, one located on each end of the clamping assembly 28, are in an unclamped position, as shown in FIG. 2, the clamping assembly 28 can be slid vertically on the dowels 38 to alter the spacing between the clamping assembly 28 and the deck 22 for insertion of a belt end into or removal of a belt end from the space between the clamping assembly 28 and the deck 22. The clamping assembly 28 can be completely removed from the deck 22, if desired, such as for removing a spliced belt after the splicing process is complete.

The clamp lever 38 includes a yoke 42 pivotally mounted at its lower end to the deck 22 at a pair of pivot connections 44, one located on each side of the yoke 42 (only one of the pivot connections 44 is visible in FIG. 2 for each of the clamp levers 38). As best seen in the exploded clamp lever 38 of FIG. 2, the yoke 42 includes an opening 46 at its bight and a slot 48 on each side to accommodate a central body 50 having a shaft 52 terminating at one end at a bulbous head 54 and at the other end at an annular flange 56. The shaft 52 sits between the sides of the yoke 42 with the upper end extending through the opening 46 such that the head 54 is positioned on the opposite side of the bight of the yoke 42, and a biasing member, such as a compression spring 58 surrounds the shaft 52 between the bight of the yoke 42 and the annular flange 56. Additionally, the central body 50 includes, below the annular flange 56, a generally cylindrical cam body 60 oriented transverse to the shaft 52 and terminating at each end at a pin 62 sized for sliding receipt within the corresponding yoke slot 48.

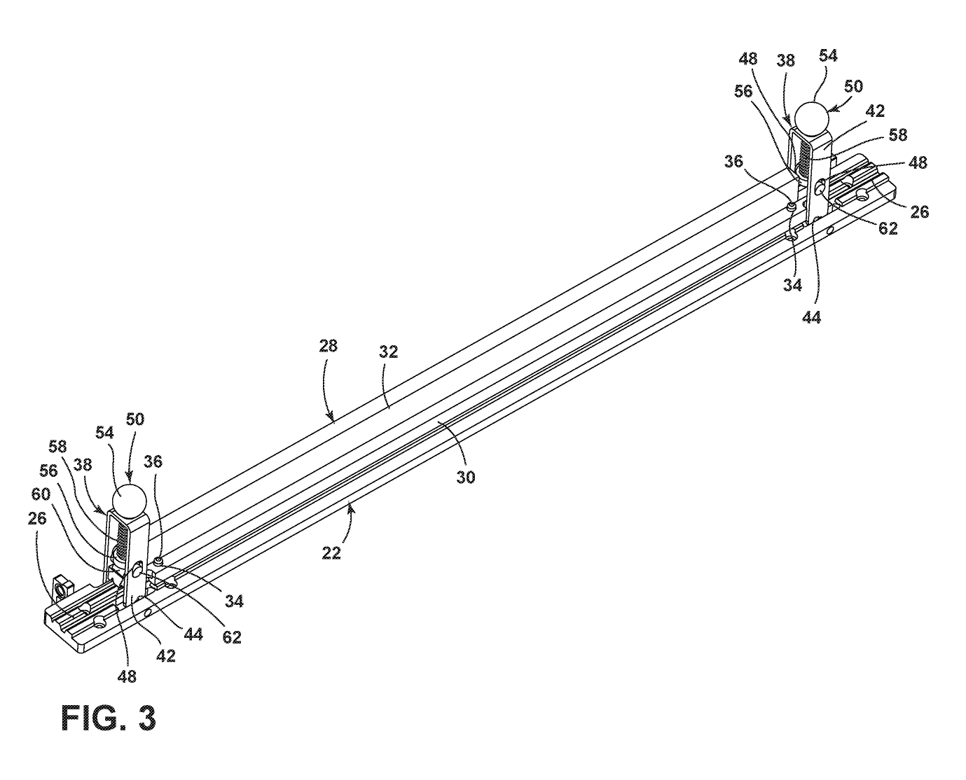

Referring again to the primary illustration of FIG. 2, the spring 58, positioned between the bight of the yoke 42 and the annular flange 56, biases the central body 50 downward until the head 54 abuts the bight of the yoke 42. The spring 58 forces the cam body 60 downward and, consequently, the pins 62 sit in the lowest position of the corresponding slots 48. The spring 58 is preferably a low rate spring so that the clamping load will be effective regardless of the thickness of the belt. When the user moves the clamp lever 38 from the unclamped position in FIG. 2 by pivoting the clamp lever 38 about the pivot connection 44, the cam body 60 rides along the cam seat 40, which initially pushes the cam body 60 and, thus, the rest of the central body 50 upward, further compressing the spring 58. During the compression, the pins 62 slide upward within the corresponding slots 48. Eventually, due to contour of the cam seat 40, the cam body 60 enters a depressed portion of the cam seat 40, thus allowing the spring 58 to expand and push the central body 50, including the cam seat 40, downward, whereby the pins 62 return to near the lowest position in the corresponding slots 48. At this point, the clamping lever 38 is generally vertical, as shown in FIG. 3, and in the clamped position applying a downward force to the clamping assembly 28. When the user moves both of the clamping levers 38 for the deck 22 to the clamped position, the clamping assembly 28 applies, at both ends of the deck 22, a downward clamping force to a belt (not shown) positioned between the deck 22 and clamping assembly 28, thus firmly holding the belt in position on the deck 22. The process is reversed for returning the clamping levers 38 to the unclamped positions. While the clamping assembly 28 and the clamping levers 38 have been described with respect to the sliding deck 22, it is to be understood that the same description applies to the clamping assembly 28 and the clamping levers 38 for the shifting deck 24 (FIG. 1).

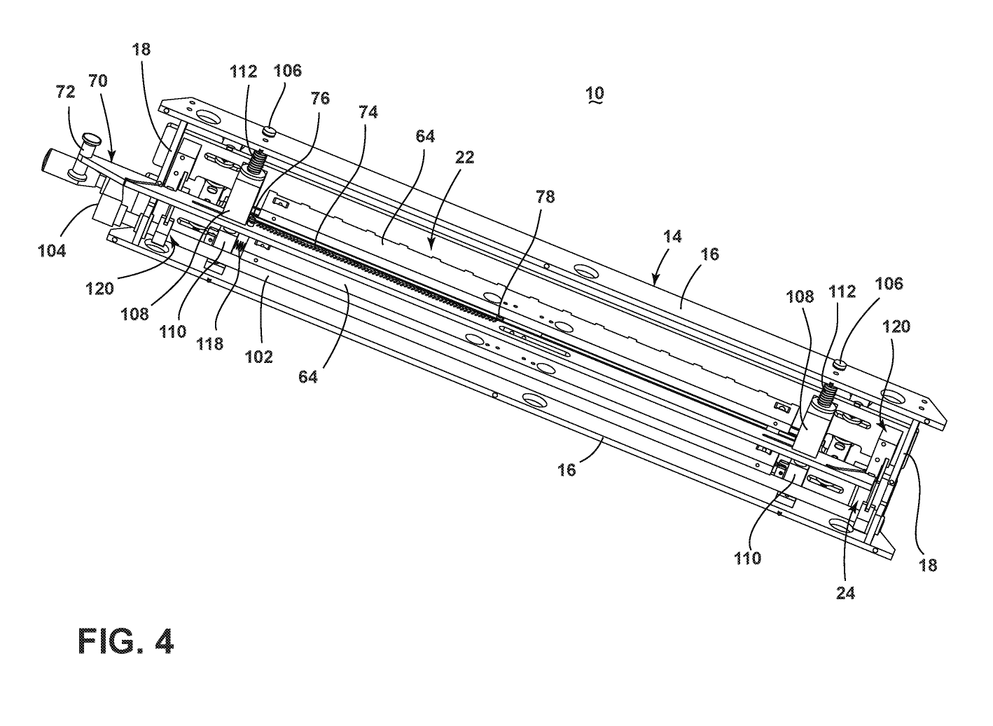

Referring now to FIG. 4, which is a perspective view of the underside of the splicer 10 with the base 12 removed to better view the components located underneath the decks 22, 24 (which will be the case with all views of the underside of the splicer 10), the decks 22, 24 each include an elongated deck stiffener 64 mounted to a lower surface of the deck 22, 24. The stiffener 64 may have any suitable configuration and is illustrated as being a generally upright right rectangular prism oriented relative to the deck 22, 24 to form a generally T-shaped transverse cross-sectional configuration. Additionally, the stiffener includes openings of various shapes and sizes and supports various structures, as will be explained below with respect to other components of the splicer 10 with which the openings and structures interact.

With continued reference to FIG. 4, an elongated heating element positioner 70 extends through one of the frame end walls 18 and along the length of and between the decks 22, 24 parallel to the deck stiffeners 64. The end of the heating element positioner 70 that extends beyond the frame 14 terminates at a handle 72. A biasing element, such as an extension spring 74, connected at its ends to a first spring boss 76 on the heating element positioner 70 and a second spring boss 78 on the deck stiffener 64 for the sliding deck 22 biases the heating element positioner 70 inward (i.e., into the area defined within the frame 14). The user can pull, using the handle 72, the heating element positioner 70 outward against the bias of the spring 74, as will be discussed in further detail below.

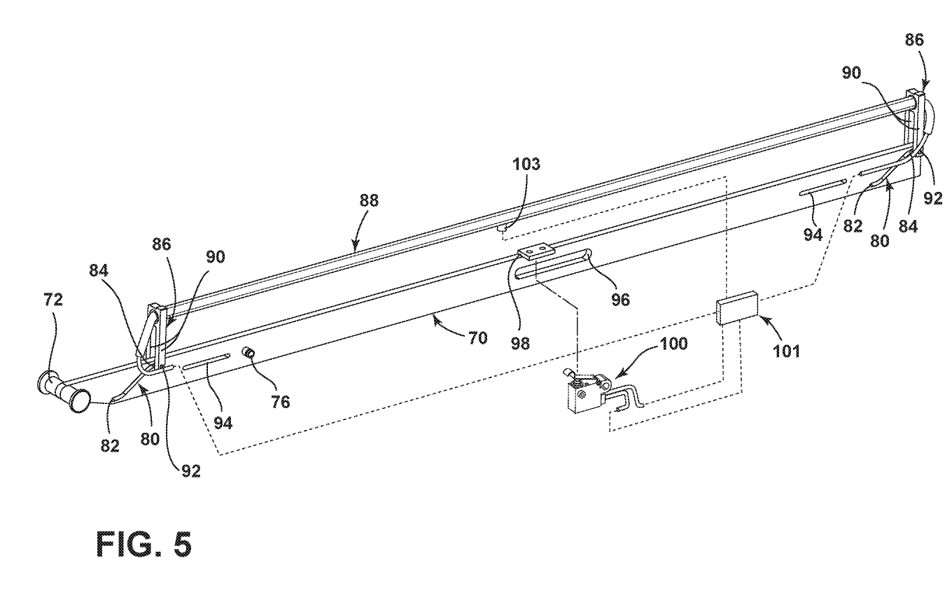

As best viewed in the perspective view of the heating element positioner 70 in FIG. 5, several slots are formed near the ends and the middle of the heating element positioner 70. In particular, both ends include a cam slot 80 that extends from a first end 82 near the lower edge of the positioner 70 to a second end 84 near the upper edge of the positioner 70, with a sloped portion connecting the first and second ends 82, 84. A heating element holder 86 mounted to each of the cam slots 80 supports an elongated heating element 88 above the heating element positioner 70. The heating element holder 86 includes a pair of legs 90 that straddle the heating element positioner 70 at the cam slot 80, and a pin 92 extends transversely through the legs 90 and the cam slot 80. The horizontal position of the heating element holder 86 is fixed (i.e., the pin 92 and the heating element holder 86 cannot move inward and outward with the heating element positioner 70), as will be explained below; however, the vertical position of the heating element holder 86 is adjustable during the inward and outward movement of the heating element positioner 70. Specifically, the cam slot 80 moves relative to the pin 92 and pulls the pin 92 downward to the first end 82 during inward movement of the heating element positioner 70 and pushes the pin 92 upward to the second end 84 during outward movement of the heating element positioner 70, thus resulting in simultaneous downward and upward movement of the heating element holder 86 and the heating element 88.

Adjacent the cam slot 80, each end of the heating element positioner 70 further includes a generally horizontal guide slot 94. Another slot, a central slot 96, is located at approximately the horizontal center of the heating element positioner 70. In addition, the heating element positioner 70 supports a heating element switch actuator 98, shown by example as being mounted to an upper edge of the heating element positioner 70. An electrical switch 100 is operably coupled with a temperature controller 101, which is operably coupled with the heating element 88. The electrical switch 100 is preferably located near the heating element positioner 70, such as by being mounted to the base 12 (FIG. 1), and interacts with the switch actuator 98 during movement of the heating element positioner 70. Outward movement of the heating element positioner 70 places the switch actuator 98 in physical contact with the electrical switch 100, thus actuating the switch 100 to actuate the temperature controller 101. The electrical switch 100 allows the temperature controller 101 to start a cycle which allows the temperature of belt ends to be spliced to rise to a point just below melting. Temperature is maintained for a time to eliminate all or nearly all moisture in the belt material. After the belt material is saturated at this temperature, the temperature then rises quickly to soften edges of the belt with minimal damage to material. A thermocouple 103 connected to the heating element 88 and to the temperature controller 101 maintains a desired temperature profile of the heating element 88. When soft, welding occurs quickly. The heating element 88, the switch 100, and the temperature controller 101 are not shown in other figures of the splicer 10 for clarity in viewing the illustrations.

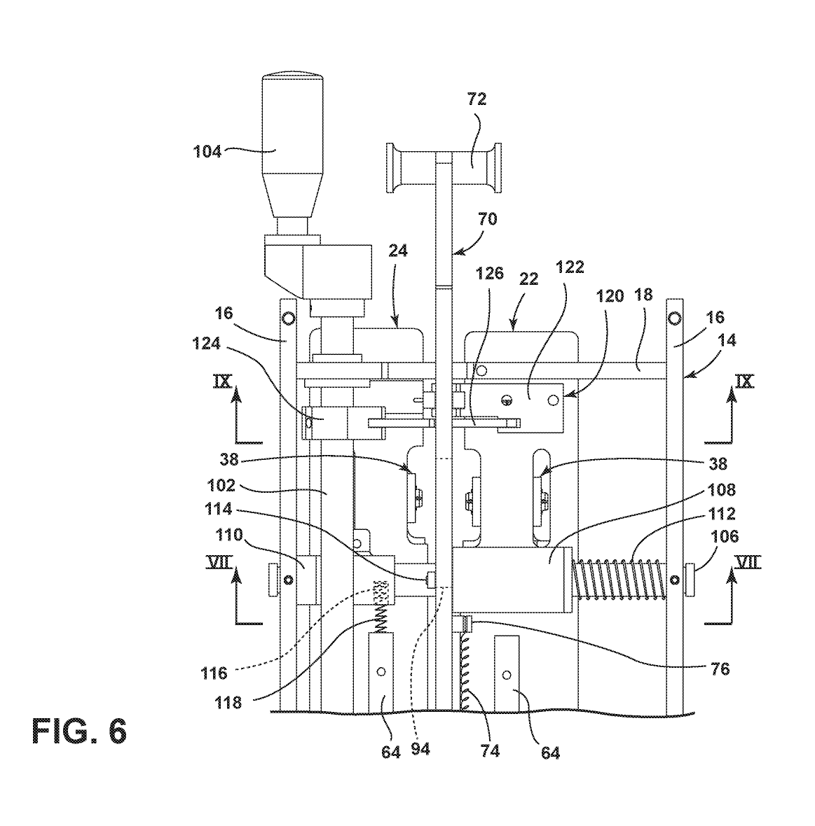

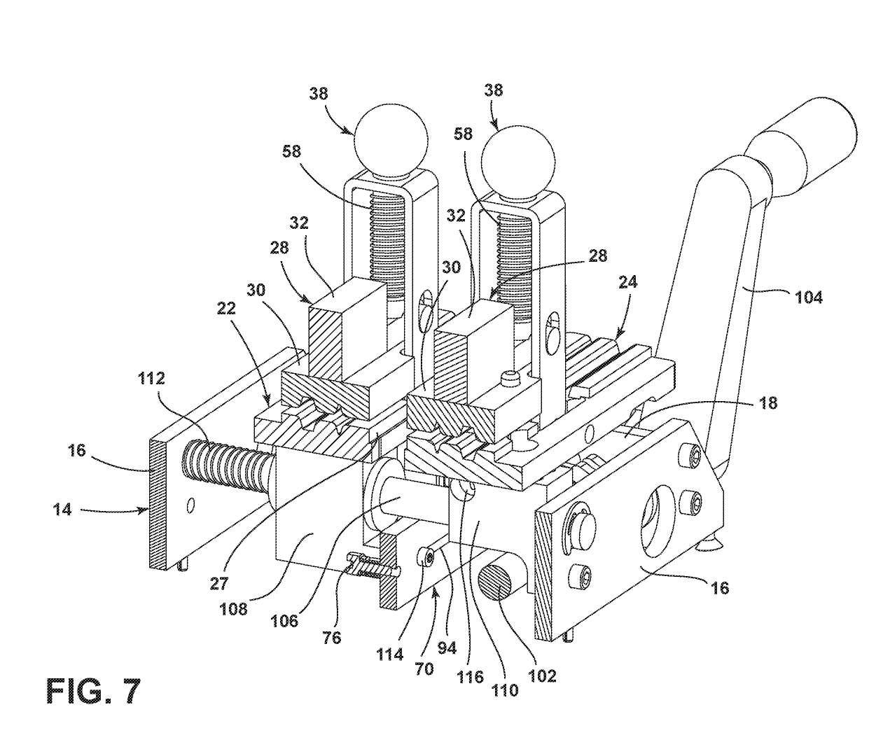

Referring again to FIG. 4, an elongated, rotatable control rod 102 has a crank handle 104 at one end and extends through one of the frame end walls 18 and along the length of the decks 22, 24 before terminating at the other frame end wall 18. Two additional rods 106, one near each end of the decks 22, 24, positioned transverse to the length of the decks 22, 24 and fixed to the side walls 16 each extend through a sliding deck support 108 mounted to the underside of the sliding deck 22 and a shifting deck support 110 mounted to the underside of the shifting deck 24. As best seen in the bottom view of one end of the splicer 10 without the base 12 in FIG. 6, a biasing member, such as a compression spring 112 positioned on the rod 106 between one of the frame side walls 16 and the sliding deck support 108 biases the sliding deck support 108 and, therefore, the sliding deck 22, towards the shifting deck support 110 and, therefore, the shifting deck 24. This direction is generally transverse to the longitudinal axis of the decks 22, 24 and will be referred to as the transverse direction hereinafter, while movement in a direction generally parallel to the longitudinal axis of the decks 22, 24 will be referred to as the longitudinal direction. The sliding deck support 108 is also coupled to the heating element positioner 70 with a pin 114 extending from the sliding deck support 108 and through the guide slot 94 of the heating element positioner 70. The pin 114 and the slot 94 are more clearly seen in the cross-sectional view of FIG. 7 taken along line VII-VII of FIG. 6. During longitudinal movement of the heating element positioner 70, the slot 94 slides relative to the pin 114, thus allowing the heating element positioner 70 to move horizontally relative to the sliding deck support 108 while remaining coupled to the sliding deck support 108. As also seen in FIG. 7, the shifting deck support 110 includes a pocket 116 on one side. Referring back to FIG. 6, the pocket 116 receives one end of a biasing member, such as a compression spring 118, and the other end of the spring 118 abuts the end of the deck stiffener 64 for the shifting deck 24, thus biasing the shifting deck 24 longitudinally away from the crank handle 104. While FIGS. 6 and 7 illustrate the elements related to the transverse rod 106 at one end of the splicer 10, it is to be understood that the same description applies to the other transverse rod 106 and the related elements at the other end of the splicer 10.

FIG. 7 also illustrates a notch 27 in the corrugated upper surface 26 of each deck 22, 24. The notches face each other so that when the decks 22, 24 are closed and the belt is spliced, the notches form a deep, narrow slot to provide space for a seam flash and assure correct pitch.

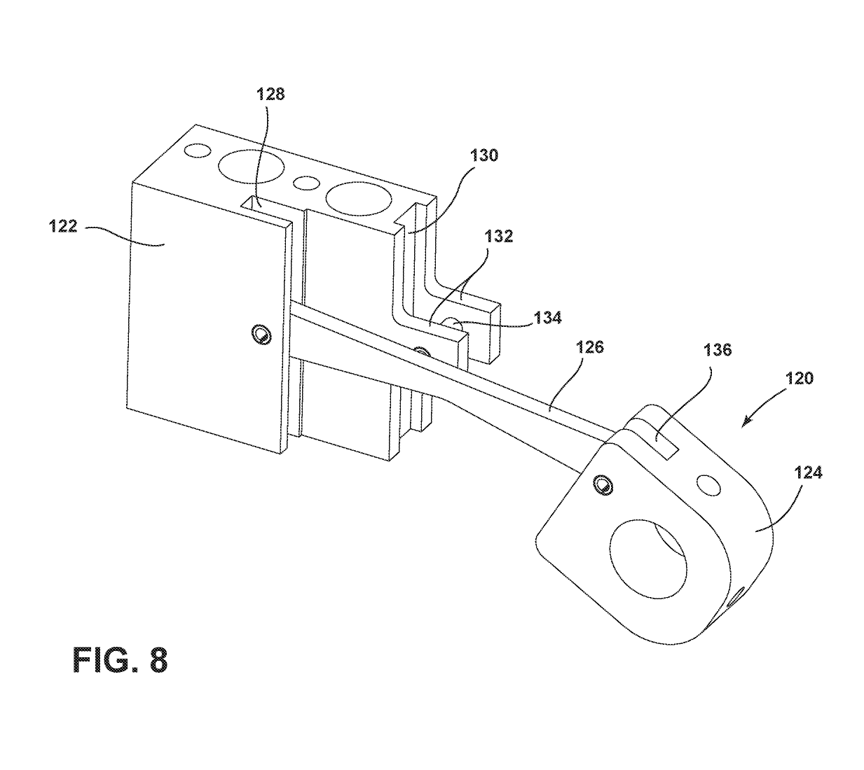

Referring again to FIG. 6, the control rod 102 is coupled to a sliding assembly 120 that effects transverse movement of sliding deck 22 away from the shifting deck 24 against the bias of the spring 112 upon rotation of the control rod 102. The sliding assembly 120 includes a deck support element 122 mounted to the underside of the sliding deck 22 for cooperative movement and a control rod element 124 mounted to the control rod 102 for rotation with the control rod 102. A rigid link 126 connects the support element 122 and the control rod element 124. As best seen in the perspective view of the sliding assembly 120 in FIG. 8, the deck support element 122 forms two vertical channels, a link channel 128 and a heating element holder channel 130, facing the control rod element 124. In addition, two spaced tabs 132, one located on each side of the heating element holder channel 130 near the vertical center of the heating element holder channel 130, extend towards the control rod element 124 with a connecting pin 134 therebetween. The control rod element 124 also forms a channel 136 along one side edge facing the deck support element 122. The link 126 is pivotally mounted at its ends to the deck support element 122 and the control rod element 124 within the respective channels 128, 136.

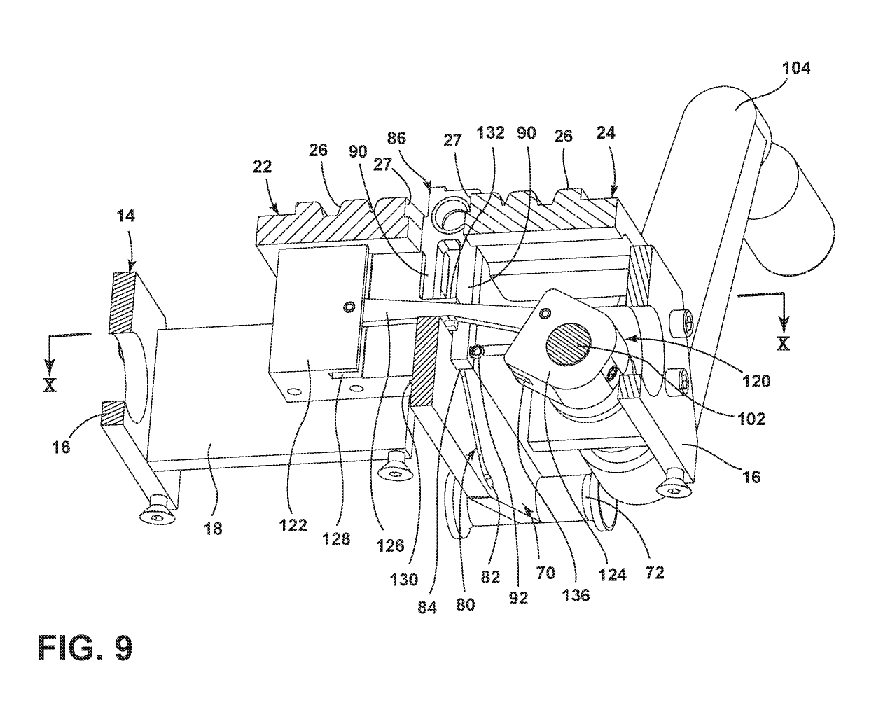

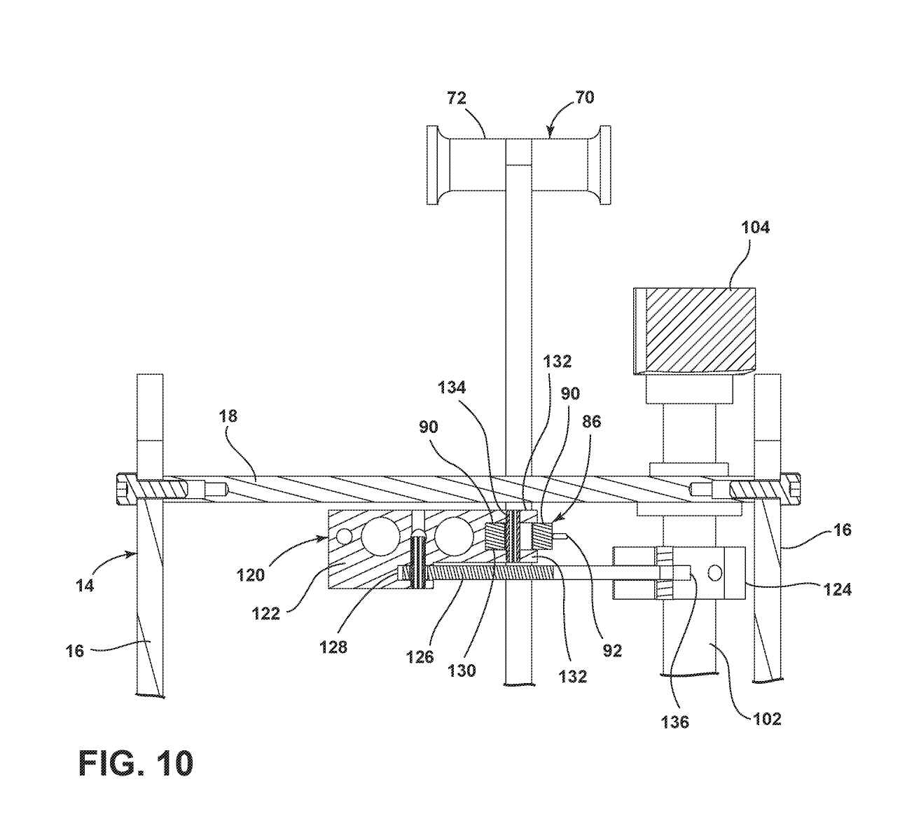

Referring now to the cross-sectional view of FIG. 9 taken along line IX-IX of FIG. 6, the heating element holder 86 is positioned vertically with a side edge of one leg 90 received within the holder channel 130 of the deck support element 122. As seen in the cross-sectional view of FIG. 10, the tabs 132 sandwich the heating element holder 86 with the pin 134 extending between the tabs 132 in the space between the holder legs 90.

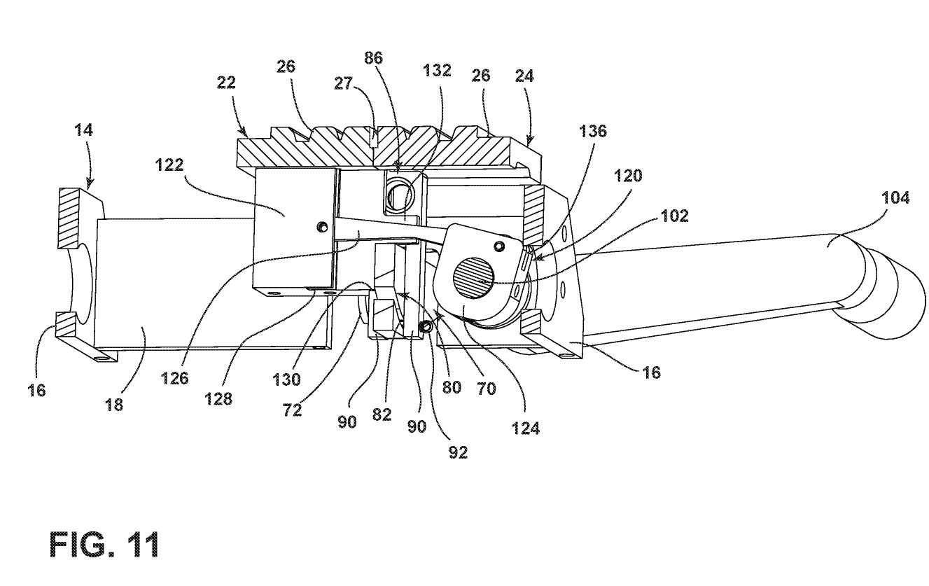

As mentioned above, the springs 112 on the transverse rods 106 (FIG. 6) bias the sliding deck 22 towards the shifting deck 24 to a closed position shown in FIG. 11, which is a cross-sectional view similar to FIG. 9 but with the sliding deck 22 in the closed position. In this position, the sliding deck element 122, under the bias applied to the sliding deck 22, forces the lever 126 to apply a torque to the control rod element 124, thus rotating the control rod element 124 and the control rod 102 in a direction away from the sliding deck element 122 (i.e., clockwise in FIG. 11), and the end of the link 126 connected to the control rod element 124 lies within the channel 136. Additionally, the heating element positioner 70 is biased to an inward position by the spring 74 (FIG. 6) such that the pin 92 is located at the first end 82 of the cam slot 80 and pulls the heating element holder 86 downward below the decks 22, 24. To open the sliding deck 22, the user rotates the crank handle 104 towards the sliding deck 22 (i.e., counterclockwise in FIG. 11) to rotate the control rod 102 and, thereby, the control rod element 124 of the sliding assembly 120. Rotation of the control rod element 124 moves the link 126 towards the deck support element 122 to push the deck support element 122 and, thereby, the sliding deck 22 away from the shifting deck 24 against the bias of the springs 112 (FIG. 7) to the opened position of FIG. 9. Additionally, the heating element positioner 70 and the heating element holder 86 move with the sliding deck 22 during its sliding movement relative to the shifting deck 24. This cooperative movement occurs because the heating element positioner 70 is connected to the sliding deck 22 through sliding deck support 108 at the pin 114 (FIG. 6), and the heating element holder 86 is connected to the sliding deck 22 through the deck support element 122 at the pin 134 (FIG. 10). Once the sliding deck 22 is fully opened, the user can pull the heating element positioner 70 outward to move the heating element holder 86 upward to the position shown in FIG. 9. In particular, during the sliding movement of the positioner 70, the pin 92 connecting the bottom of the holder legs 90 moves within the cam slot 80 to the second end 84, thus pushing the holder 86 upward, and the holder 86 slides vertically within the holder channel 130 with the pin 134 (FIG. 10) moving vertically within the space between the holder legs 90. When the user ceases applying the rotational force to the crank handle 104, the sliding deck 22 moves, under the bias, back towards the shifting deck 24, but the heating element holder 86 positioned between the decks 22, 24 prevents the sliding deck 22 from returning to the closed position. Additionally, the compressive force applied to the heating element holder 86 retains the heating element holder 86 in the upward position and, thus, the heating element positioner 70 in the outward position such that the user need not apply a continuous outward force to the positioner 70 to keep the heating element holder 86 in the upward position.

In this position, the switch 100 starts the heating cycle wherein the heating element 88 heats the belt ends to a melt temperature and once the heating cycle is complete, the temperature controller 101 signals the end of the cycle. At the end of the cycle, the sliding deck 22 needs to be returned to the closed position.

To return the sliding deck 22 to the closed position, the user turns the crank handle 104 toward the sliding deck 22 to rotate the control rod 102 a small amount, just enough to move the sliding deck 22 away from the shifting deck 24 a distance sufficient release the compressive force from the heating element holder 86. Upon release of the compressive force, the spring 74 (FIG. 6) pulls the heating element positioner 70 inward, thus causing the pin 92 connecting the bottom of the holder legs 90 to move within the cam slot 80 to the first end 82, thereby pulling the holder 86, which slides quickly vertically downward within the holder channel 130 due to spring 74. After the heating element holder 86 retracts below the decks 22, 24, as in FIG. 11, the user can gently release the force applied to the crank handle 104 to allow the springs 112 (FIG. 6) to push the sliding deck 22 towards the sliding deck 24 to the closed position. During the sliding movement, the sliding deck support 122 pushes the link 126 towards the control rod element 124, thus applying a torque to the control rod element 124, which rotates away from the sliding deck 22, and causing the control rod 102 to rotate in the same direction. The user may apply a slight counter force to the crank handle 104 during the return of the sliding deck 22 to the closed position, to control the speed at which the sliding deck 22 moves due to the bias of the springs 112 (FIG. 6). The heating element positioner 70 and the heating element holder 86 move with the sliding deck 22 as it returns to the closed position.

As just explained, the sliding assembly 120 facilitates sliding movement of the sliding deck 22 in the transverse direction upon rotation of the control arm 102. As shown in FIG.

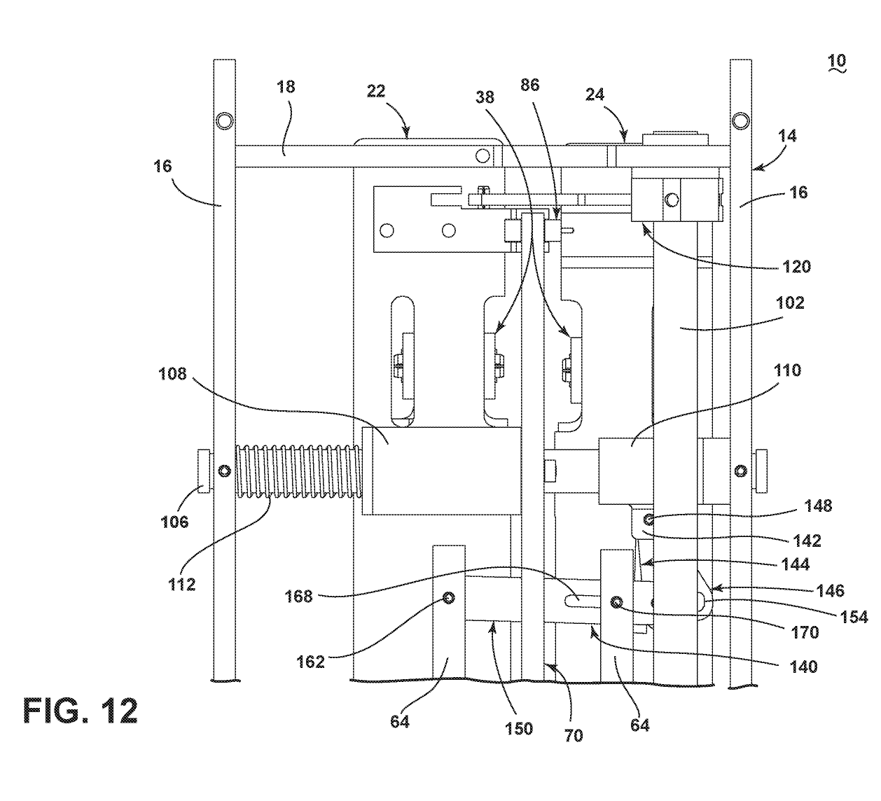

12, which is a bottom view of the splicer 10, similar to FIG. 6 but at the opposite end of the device, the splicer 10 further includes a shifting assembly 140 that facilitates shifting movement of the shifting deck 24 relative to the sliding deck 22 in the longitudinal direction in response to the position of the sliding deck 22. While the shifting assembly 140 can be positioned in any suitable location on the splicer 10, the shifting assembly 140 of the present embodiment is disposed at the end of the splicer 10 opposite the crank handle 104 (FIG. 1) and is mounted to the shifting deck support 110, particularly to a pair of tabs 142 (only one on top is visible in FIG. 12) extending inwardly from the shifting deck support 110. The shifting assembly 140 includes a strut 144 and a pawl 146 both pivotally mounted at one end to and between the tabs 142 at a pivot connection 148 and a link 150 operably coupled to the other ends of the strut 144 and the pawl 146.

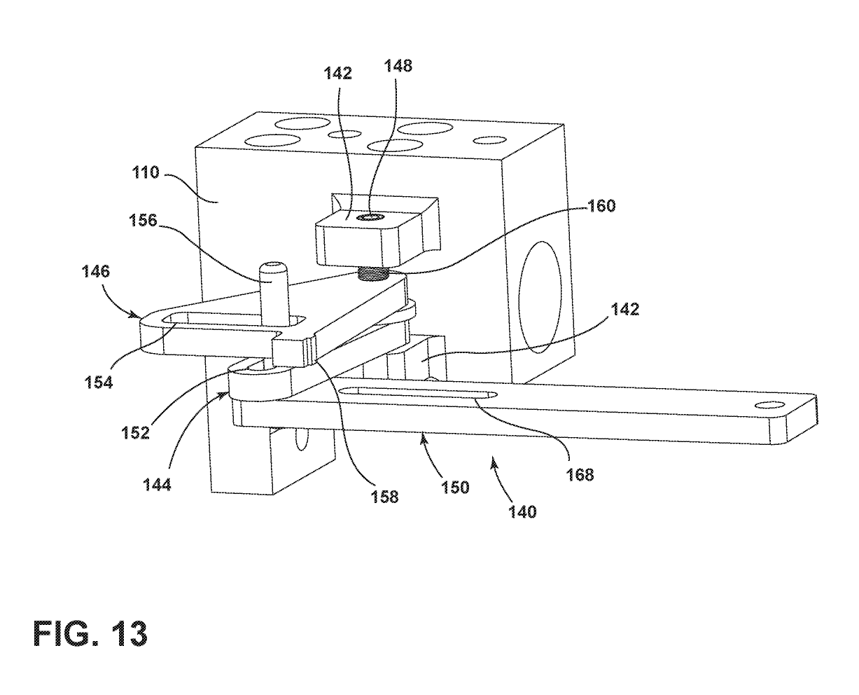

The strut 144, the pawl 146, and the link 150 are more clearly seen in the perspective view of the shifting assembly 140 and the shifting deck support 110 in FIG. 13. The strut 144 includes an elongated slot 152 at the end opposite the pivot connection 148, and the pawl 146 has a generally triangular configuration and includes an elongated slot 154 along its edge opposite the pivot connection 148. The strut slot 152 and the pawl slot 154 overlap one another and receive a dowel 156 extending upward from the link 150 to operably couple the strut 144 and the pawl 146 to the link 150. The pawl 146 further includes a laterally extending tooth 158 at the end opposite the pivot connection 148 beyond the pawl slot 154. Additionally, a biasing member, such as a torsion spring 160 mounted on a pivot pin (end shown) that extends between the tabs 142 to form the pivot connection 148, biases the pawl 146 in the direction that the tooth 158 extends. For example, one end of the spring 160 can interact with the shifting deck support 110, while the other end of the spring 160 can hook onto the pawl 146 to bias the pawl 146 in the desired direction.

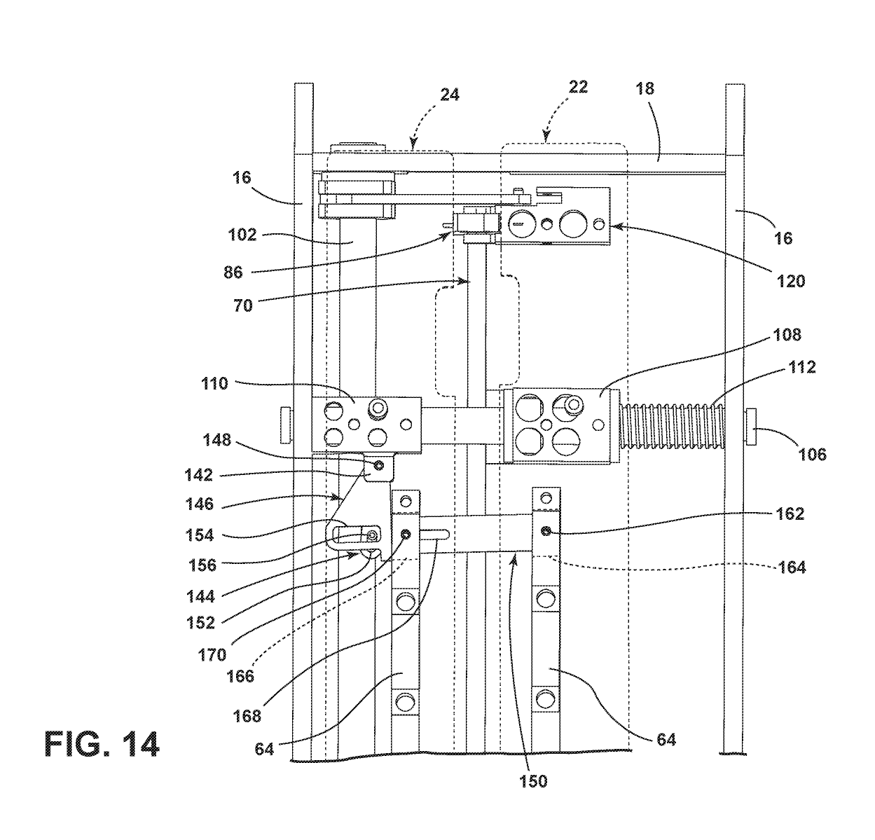

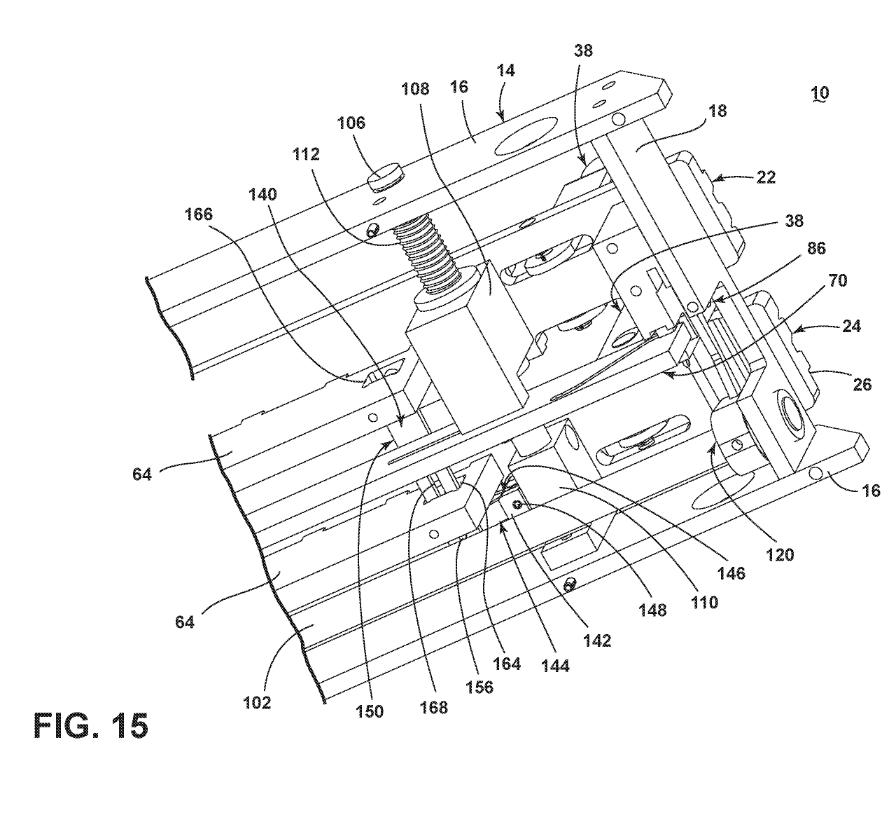

Referring to the top view of the splicer 10 in FIG. 14, where the clamping assemblies 28 (FIG. 1) have been removed and the decks 22, 24 are shown outlined in phantom for clarity, the link 150 is fixedly mounted at one end, such as by a pin 162, within an opening 164 in the deck stiffener 64 for the sliding deck 22. The link 150 extends laterally from the sliding deck 22 towards the shifting deck 24 and through a similar opening 166 in the deck stiffener 64 for the shifting deck 24. The dowel 156 is fixedly mounted to the other end of the link 150, which projects beyond the deck stiffener 64 for the shifting deck 24. An elongated longitudinal slot 168 on the link 150 receives a pin 170 that extends vertically within the deck stiffener opening 166 such that the link 150 can slide relative to the shifting deck 24 and its stiffener 64 as the sliding deck 22 moves in the transverse direction. The openings 164, 166 are more clearly visible in the bottom perspective view of FIG. 15.

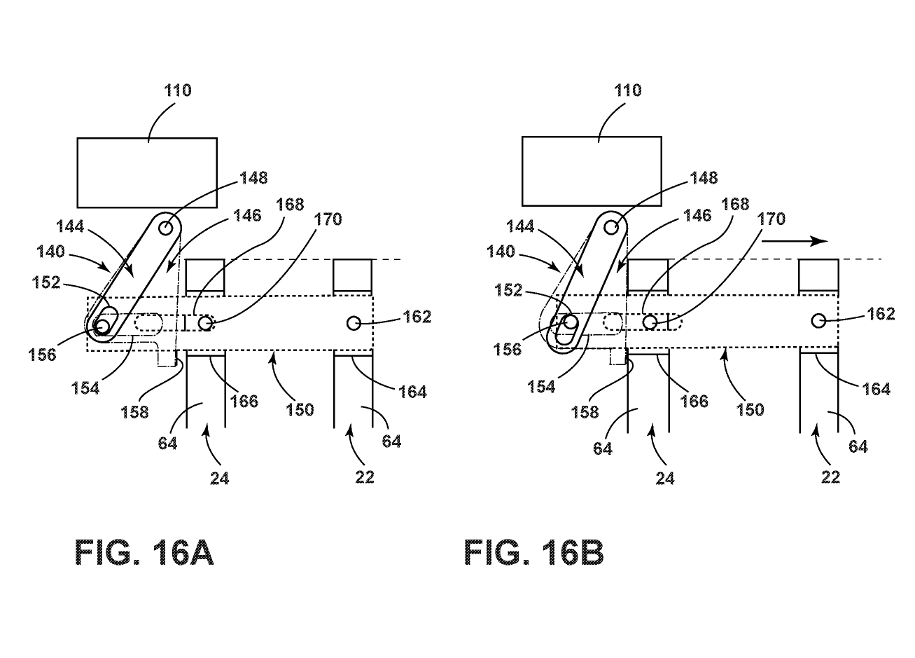

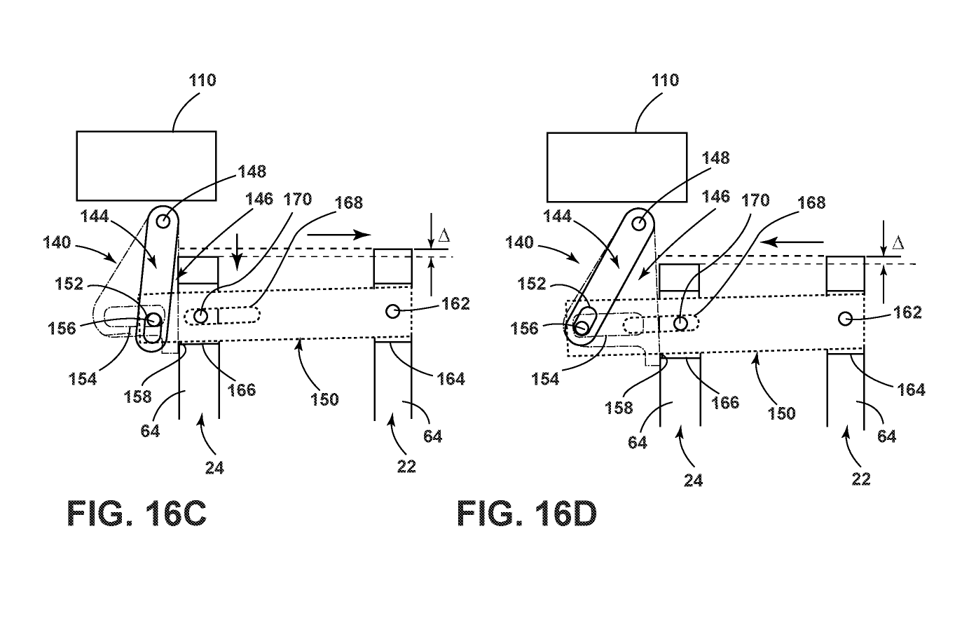

FIGS. 16A-16D schematically illustrate a process of the shifting assembly 140 moving the shifting deck 24 in the longitudinal direction as the sliding deck 22 moves between the closed and opened positions in the transverse direction. The strut 144, the pawl 146, and the link 150 are drawn with different line types in these figures for clarity in viewing and distinguishing the parts from one another. In FIG. 16A, the sliding deck 22 is closed (as in FIG. 11), and the spring 118 (FIG. 6) biases the shifting deck 24 to an aligned position wherein the ends of the decks 22, 24 are generally colinear, as represented by the ends of the deck stiffeners 64 being colinear. Using the orientation of FIGS. 16A-16D (e.g., right, left, up, down) for ease of description, the shifting link 150 is positioned as far left as possible with the shifting deck pin 170 at the rightmost location within the slot 168. The dowel 156 at the end of the link 150 is positioned at the lowermost location in the strut slot 152 and at the leftmost location in the pawl slot 154, rotating the strut 144 and the pawl 146 clockwise against the bias of the spring 160 (FIG. 13) and spacing the pawl tooth 158 from the stiffener 64 for the shifting deck 24. As the sliding deck 22 moves transversely away from the shifting deck 24 in FIG. 16B, the link slot 168 slides relative to the shifting deck pin 170, and the dowel 156 pulls the strut 144, which is floating on the dowel 156 as the dowel 156 moves to the uppermost position in the strut slot 152, to rotate counterclockwise towards the shifting deck stiffener 64. Because the pin 170 has moved from the leftmost position in the pawl slot 154, the pawl 164, under the bias of the spring 160, rotates counterclockwise into contact with the side edge of the shifting deck stiffener 64. Looking at FIG. 16C, when the sliding deck 22 reaches the opened position (as in FIG. 9), the dowel 156 has pulled the strut 144 to a position where the top of the strut slot 152 pushes downward on the dowel 156 and, thereby, the link 150, which effectively pivots about the sliding deck pin 162. The link slot 168 pulls the shifting deck pin 170 downward during the pivoting of the link 150, which forces the sliding deck stiffener 64 and, thus, the sliding deck 24 to shift longitudinally downward, away from the shifting deck support 110, to a shifted position. As the stiffener 64 moves downward, the pawl tooth 158 slides into the opening 166 between the link 150 and the wall forming the opening 166, and the spring 160 (FIG. 13) retains the tooth 158 in the opening 166 to retain the shifting deck 24 in the shifted position.

As shown in FIG. 16D, during the return of the sliding deck 22 from the opened position, the link moves to the left with the sliding deck 22. The link slot 168 slides to the left along the shifting deck pin 170, and the dowel 156 pushes the strut 144, which is floating on the dowel 156, to rotate clockwise. The dowel 156, while pushing the strut 144, moves to the left along the pawl slot 154, but the pawl tooth 158 remains engaged with the opening 166 due to the bias of the spring 160 (FIG. 13) and continues to hold the shifting deck 24 in the shifted position. Returning to FIG. 16A, as the sliding deck 22 reaches the closed position, the dowel 156 reaches the leftmost position of the pawl slot 154 and forces the pawl 146 to rotate clockwise against the bias of the spring 160, thereby releasing the pawl tooth 158 from the opening 166 and allowing the spring 118 (FIG. 6) to shift the shifting deck 24 upward towards the shifting deck support 110 to the aligned position. It will be understood that the shift occurs after the molten edges of the belt contact each other.

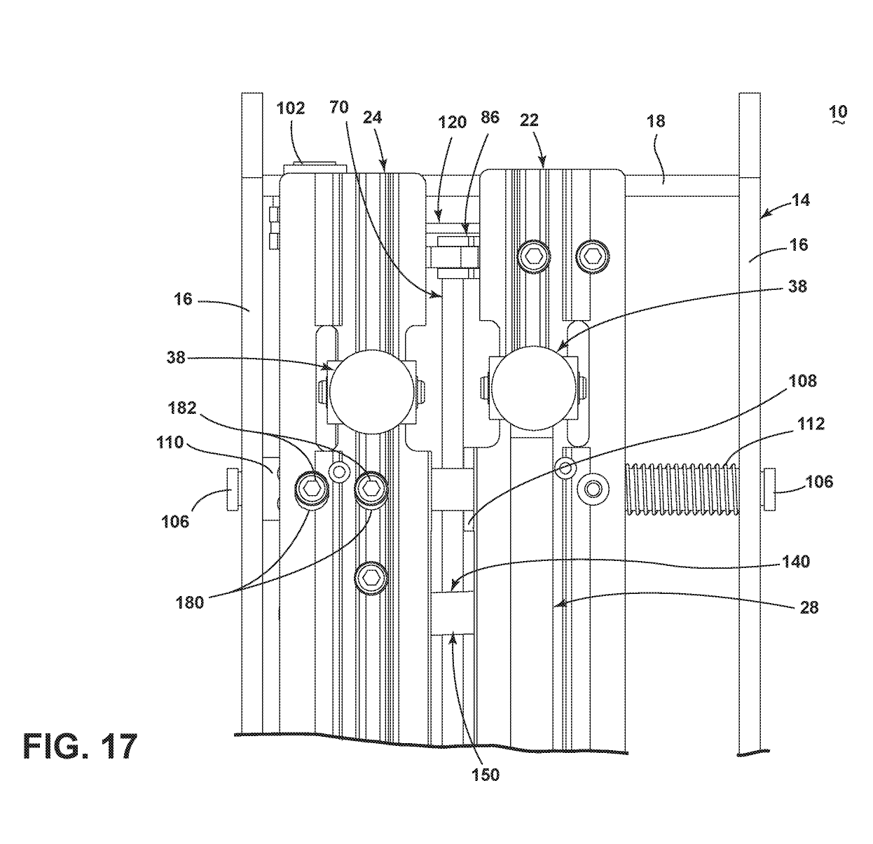

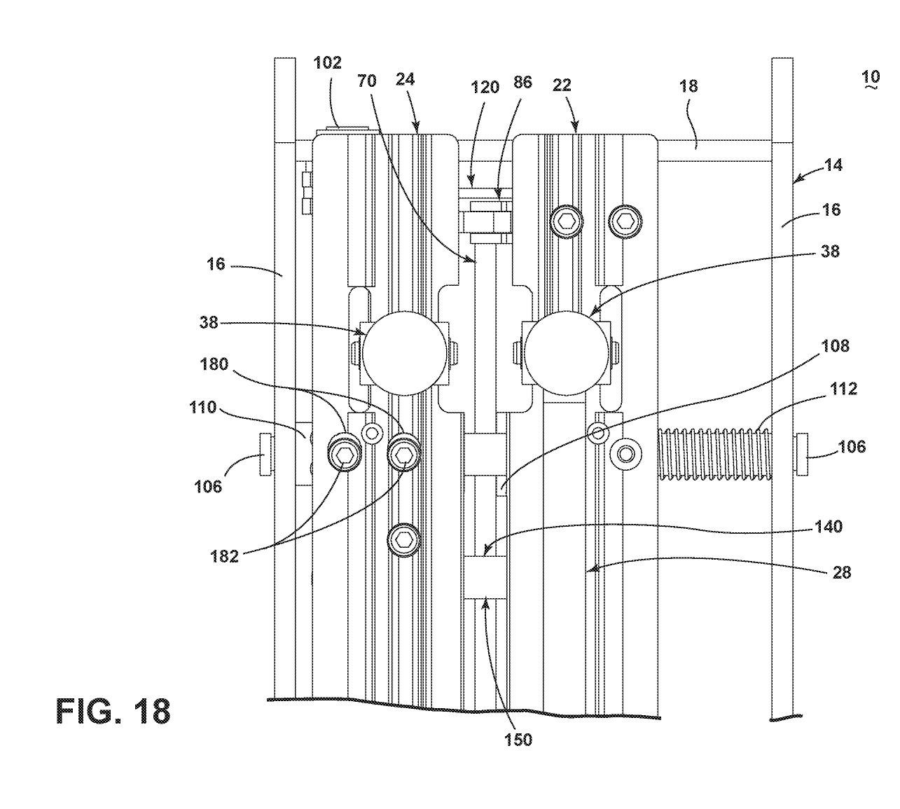

Referring now to the top view of one end of the splicer 10 in FIG. 17, where the clamping assembly 28 for the shifting deck 24 is removed for viewing the upper surface 26 of the shifting deck 24, to allow longitudinal movement of the shifting deck 24 relative to the shifting deck support 110, the shifting deck 24 includes elongated fastener openings 180 having a length at least equal to the distance that the shifting deck 24 moves during movement between the aligned and shifted positions. In FIG. 17, the shifting deck 24 is in the shifted position with mechanical fasteners 182 coupling the shifting deck 24 to the shifting deck support 110 located at one end of the openings 180. When the shifting deck 24 moves to the aligned position, shown in FIG. 18, the openings 180 move with the shifting deck 24 relative to the fasteners 182 and the shifting deck support 110. Once the shifting deck 24 is in the shifted position, the fasteners 82 reside at the opposite end of the openings 180.

The operation of the belt splicer 10 will now be described, with it being understood that the operation can proceed in any suitable manner and may be adapted according to the particular configuration of the splicer 10. Additionally, the description below provides an overview of the operation of the splicer 10 and refers to the sliding assemblies 120, the shifting assembly 140, and other structures explained in detail above. The overview does not repeat the detailed description of such assemblies and structures but inherently refers to the previously provided explanations.

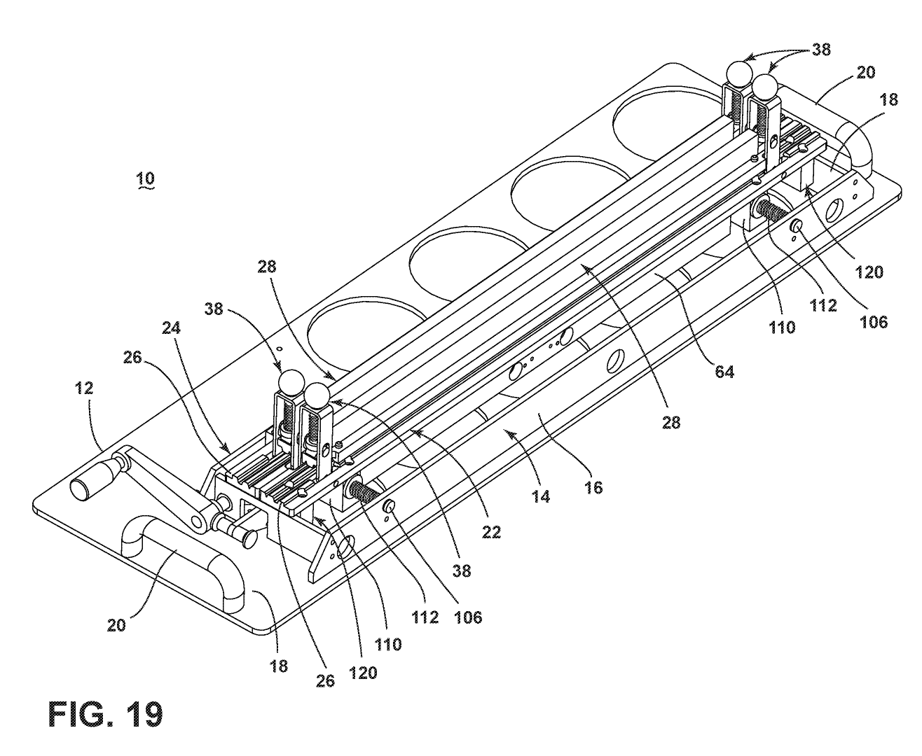

Referring to the perspective view of the splicer 10 in FIG. 19, at the beginning of the operation, the splicer 10 is in a condition wherein the sliding deck 22 and the shifting deck 24 are in the closed and aligned positions, respectively. The sliding deck 22 may abut the shifting deck 24 along their mating side edges when in the closed position or, alternatively, may be slightly spaced from the shifting deck 24, if desired. The sliding assemblies 120 assume the condition shown in FIG. 11, and the springs 112 force the sliding deck 22 to the closed position. Additionally, the spring 74 (FIG. 6) pulls the heating element positioner 70 inward to the position shown in FIG. 11, where the pin 92 sits at the first end 82 of the cam slot 80, thus pulling the heating element holder 86 and the heating element 88 downward below the decks 22, 24. As mentioned above, the ends of the decks 22, 24 are generally collinear when the shifting deck 24 is in the aligned position. The shifting assembly 140 assumes the condition shown in FIG. 16A, and the spring 118 (FIG. 6) forces the shifting deck 24 to the aligned position. The decks 22, 24 are open enough for a step portion of top of heating element holder 86 to be trapped between shifting deck 24 and sliding deck 22. In this position, shifting has not started and ends of belt sections can be lined up longitudinally, because they are near to each other but not touching. Belt sections are longer than half finished length to allow for extra material to make a splice.

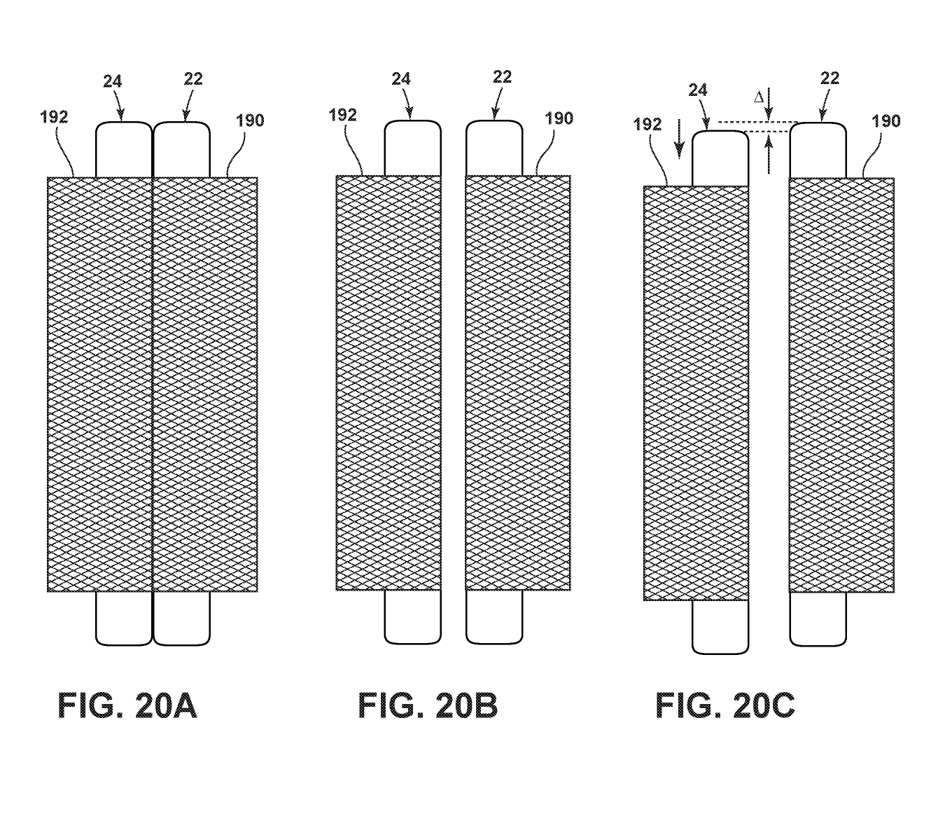

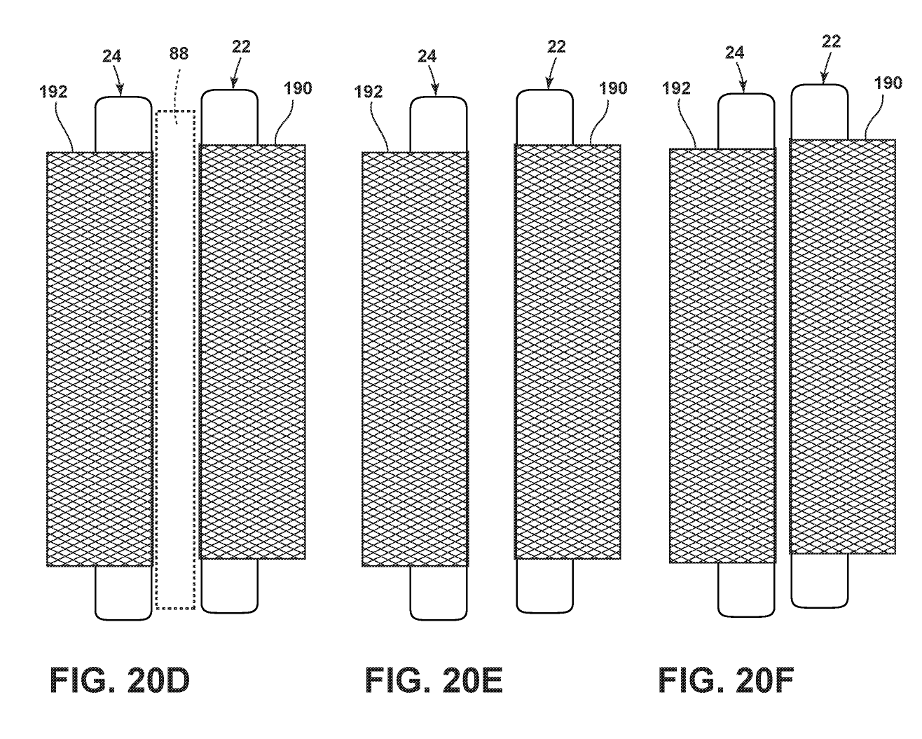

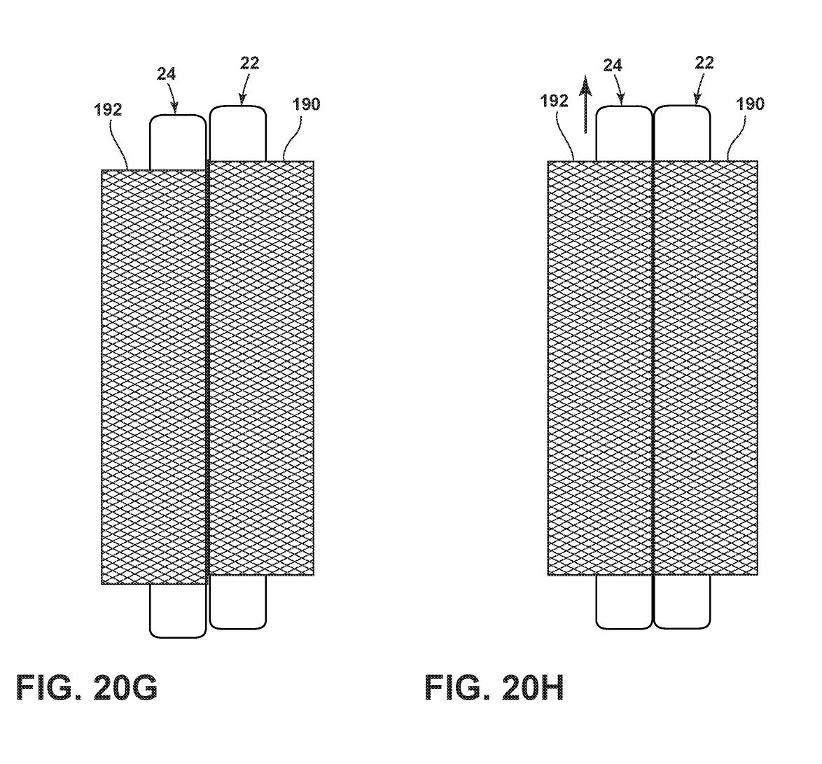

Referring to FIG. 19, the user loads two belt ends into the splicer 10. One of the belt ends is loaded onto the sliding deck 22 between the clamping assembly 28 and the upper surface 26 of the sliding deck 22, and the other of the belt ends is loaded onto the shifting deck 24 between the clamping assembly 28 and the upper surface 26 of the shifting deck 24. The process for operating the clamping assemblies 28 and the corresponding clamp levers 38 is described above with respect to FIGS. 2 and 3. FIG. 20B provides a schematic illustration of two belt ends 190, 192 loaded onto the decks 22, 24. The mating edges of the belts 190, 192 are positioned so that they are in abutting contact with one another when the sliding deck 22 is in the closed position.

Next, the user rotates the crank handle 104 to move the sliding deck 22 in the transverse direction away from the shifting deck 24, as depicted in FIG. 20B, and space the mating edges of the belt ends 190, 192 from one another. As described earlier, rotation of the crank handle 104 and, thereby, the control rod 102 causes the sliding assemblies 120 to move from the condition shown in FIG. 11, corresponding to the sliding deck closed position, toward the condition shown in FIG. 9, corresponding to the sliding deck opened position. Because of the attachment of the heating element positioner 70 to the sliding deck assemblies 120, the heating element positioner 70 moves transversely with the sliding deck 22. Simultaneously, the shifting assembly 140 moves to the condition shown in FIG. 16B as the link 150 moves with the sliding deck 22, but the shifting deck 24 remains in the aligned position.

When the sliding assemblies 120 reach the condition shown in FIG. 9, the sliding deck 22 is in the opened position depicted in FIG. 20C. The user must continue to apply force to the crank handle 104 to retain the sliding deck 22 in the opened position and prevent the springs 112 (FIG. 6) from returning the sliding deck 22 to the closed position. Additionally, when, or just before, the sliding deck 22 reaches the opened position, the shifting assembly 140 assumes the condition of FIG. 16C to move the shifting deck 24 to the shifted position. As seen in FIG. 20C, the shifting deck 24 shifts longitudinally a distance A relative to the sliding deck 22, and the belt end 192 likewise shifts the distance A relative the belt end 190.

With the sliding deck 22 in the opened position, the user can insert the heating element 88 between the belt ends 190, 192, as depicted in FIG. 20D. To this end, as described above in detail with respect to FIG. 5, the user pulls the heating element positioner 70 outward, thereby moving the cam slot 80 relative to the pin 92 until the pin 92 is located in the second end 84 of the cam slot 80 to push the heating element holder 86 and the heating element 88 upward between the decks 22, 24, as shown in FIG. 9. The user can then release the force from the crank handle 104 because the heating element holder 86 positioned between the decks 22, 24 prevents the sliding deck 22 from returning the closed position. Concurrently, the force applied to the sliding deck 22 by the springs 112 (FIG. 6) compresses the heating element holder 86 between the decks 22, 24 and holds the heating element holder 86 in the upward position and the heating element positioner 70 in the outward position. The sliding deck 22 moves a small distance towards the shifting deck 24 upon the release of the crank handle 24, assuming that the heating element holder 86 has a width slightly smaller than the distance between the decks 22, 24 in the fully opened position. Referring again to FIG. 5, the heating element 88 activates when the switch actuator 98 engages the switch 100 during the outward movement of the heating element positioner 70. As depicted in FIG. 20D, the heating element 88 is sufficiently close to the mating edges of the belt ends 190, 192, such as by being in contact with the belt ends 190, 192 or slightly spaced from the belt ends 190, 192, to begin cycle to dry and then heat the mating edges to at least a partially molten state.

After the heating cycle of the belt ends 190, 192, the user moves the sliding deck 22 to the fully opened position depicted in FIG. 20E by rotating the crank handle 104. Once the sliding deck 22 moves transversely away from the shifting deck 24, the spring 74 (FIG. 6) pulls the heating element positioner 70 inward to return to the position shown in FIG. 11, where the heating element holder 86 and the heating element 88 are retracted below the decks 22, 24. Further, the heating element 88 deactivates upon disengagement of the switch actuator 98 from the switch 100 (FIG. 5) as the heating element positioner 70 moves inward.

With the heating element holder 86 and the heating element 88 retracted, the user allows the sliding deck 22 to move toward the closed position, as depicted in FIG. 20F, by releasing the force from the crank handle 104 to allow the springs 112 (FIG. 6) to push the sliding deck 22 transversely toward the shifting deck 24. When the sliding deck 22 reaches the closed position depicted in FIG. 20G with the at least partially molten mating edges of the belt ends 190, 192 in contact with one another, the sliding assemblies 120 again assume the condition shown in FIG. 11 with the springs 112 (FIG. 6) holding the sliding deck 22 in the closed position.

Just before sliding deck 22 reaches the closed position after the mating edges of the belt ends 190, 192 are in contact with one another, the shifting assembly 140 moves from the condition of FIG. 16D, where the shifting deck 24 is in the shifted position, to the condition of FIG. 16A, where the shifting deck 24 moves in the longitudinal direction the distance 4 to return to the aligned position. The movement of the shifting deck 24 relative to the sliding deck 22 causes the belt end 192 to also shift the distance 4 relative to the belt end 190 from the position depicted in FIG. 20G to that depicted in FIG. 20H. During the shifting of the belt end 190, the at least partially molten mating edges of the belt ends 190, 192 remain in contact with one another. The relative movement of the mating edges in the direction parallel to the interface of belt ends 190, 192 (i.e., perpendicular to the belt longitudinal axis) imparts a shearing effect at the at least partially molten interface and facilitates formation of an improved joint between the two belt ends 190, 192 as compared to joining the belt ends 190, 192 with movement of the belts only in the direction perpendicular to the interface. While the distance 4 can be any suitable distance to facilitate formation of the improved joint, an exemplary range for the distance 4 is from about 0.75 mm (0.03 in.) to about 1.5 mm (0.06 in.). The particular distance 4 can depend on several factors, including the type of belt, the belt material(s), the size (e.g., width, thickness) of the belt, and the molten condition of the belt mating edges. The particular distance 4 should be selected to ensure formation of a joint between the belt ends 190, 192 without tearing at the joint, which can occur with excessive shifting of the deck 24.

Once the belt ends 190, 192 have been joined and are sufficiently cooled, the spliced belt can be removed from the splicer 10 by releasing the clamp levers 38, as shown in FIG. 2, and removing the clamping assemblies 28 from the decks 22, 24 by sliding the clamping assemblies 136 upward on the dowels 36. After the spliced belt is sufficiently cooled and removed from the splicer 10, flash can be trimmed from the top and bottom surfaces of the splice. This should be done with a straight ended knife, because a v-notch blade will leave a divot at the seam, which weakens the joint.

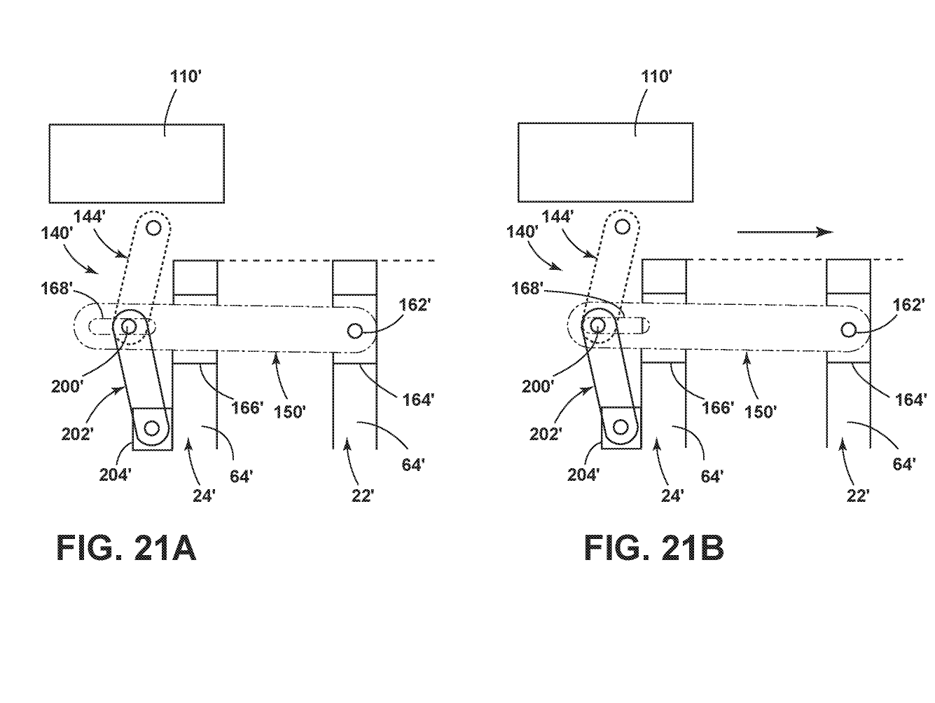

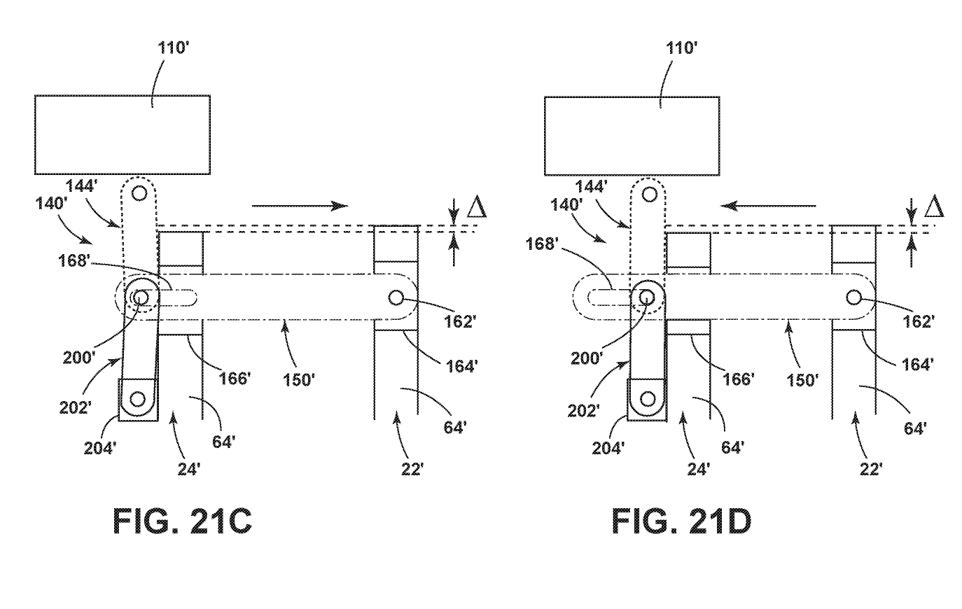

The particular assemblies of the splicer 10, including the clamping assemblies 28, the sliding assemblies 120, the shifting assembly 140, and the assemblies related to the heating element 88, may differ from that described above in the first embodiment and need not comprise the same structure to achieve the same function. For example, FIGS. 21A-21D illustrate an alternative embodiment for a shifting assembly 140′ to move the shifting deck 24′ in the transverse direction relative to the sliding deck 22′. In these figures and the following description, elements are identified with a reference numeral bearing a prime symbol (′), with elements that correspond to those of the first embodiment labeled with the same reference numeral bearing the prime symbol.

As shown in FIG. 21A, the shifting assembly 140′ is mounted, as in the first embodiment, to the shifting deck support 110′ and includes a shift link 150′ mounted within the opening 164′ in the stiffener 64′ of the sliding deck 22′ for concurrent movement with the sliding deck 22′. The link 150′ extends towards and through the opening 166′ in the stiffener 64′ of the shifting deck 24′. An elongated slot 168′ near the end of the link 150′ receives a pivot pin 200′ forming a pivot connection between a first strut 144′ pivotally connected at its opposite end to the shifting deck support 110′ and a second strut 202′ pivotally connected at its opposite end to a shifting deck mount 204′ fixedly coupled to the shifting deck stiffener 64′ for concurrent movement with the shifting deck 24′.

In FIG. 21A, the sliding deck 22′ and the shifting deck 24′ are in the closed and aligned positions, respectively. Using the orientation shown in FIG. 21A for ease of description, the shifting assembly 140′ is in a condition where the link 150′ is in its left-most position, and the pivot pin 200′ is located between the ends of the slot 168′. The first and second struts 144′, 202′ are oriented with an obtuse angle therebetween and point in the transverse direction away from the shifting deck stiffener 64′. As the sliding deck 22′ moves in the transverse direction away from the shifting deck 24′, depicted in FIG. 21B, the sliding deck 22′ pulls the link 150′ in the same direction, with the link slot 168′ moving in the same direction, bringing the left end of the slot 168′ closer to the pivot pin 200′. Referring now to FIG. 21C, as the sliding deck 22′ reaches the opened position, the slot 168′ engages the pivot pin 202′ and pulls the pivot pin 202′ toward the shifting deck stiffener 64′, forcing the struts 144′, 202′ to a generally vertical position before reaching a slight over-center position shown in the figure. Such movement of the struts 144′, 202′ through the vertical position applies a downward shifting force to the shifting deck mount 204′, thereby moving the shifting deck 24′ to the shifted position. When the struts 144′, 202′ reach the over-center position pointing towards the shifting deck stiffener 64′, the struts 144′, 202′ effectively lock the shifting deck 24′ in the shifted position. So, upon return of the sliding deck 22′ towards the shifting deck 24′, the shifting deck 24′ remains in the shifted position as the link slot 168′ moves relative to the pivot pin 200′. Once the slot 168′ engages the pivot pin 200′, the shifting deck 24′ continues to remain in the shifted position as the slot 168′ pushes the pivot pin 200′ to the left, moving the struts 144′, 202′ from the over-center position of FIG. 21C to the generally vertical position of FIG. 21D. Just before the sliding deck 22′ reaches the closed position and molten belt edges have made contact, the slot 168′ forces the pivot pin 200′ to pull the struts 144′, 202′ from the vertical position to point in the direction shown in FIG. 21A with an obtuse angle therebetween, whereby the struts 144′, 202′ apply an upward shifting force to the shifting deck mount 204′ and return the shifting deck 24′ to the aligned position. The movement of the shifting deck 24′ from the shifted position to the aligned position imparts the aforementioned shearing force to the mating edges of belt ends supported by the decks 22′, 24′ to facilitate formation of an improved joint.

Other variations of the belt splicer 10 are contemplated. For example, the splicer 10 can be adapted to uncouple the shifting movement of the shifting deck 24 from the sliding movement of the sliding deck 22. The user could manually control the movement of the shifting deck 24. Alternatively, the movement of the shifting deck 24 can occur completely during the return of the sliding deck 22 to the closed position (e.g., the shifting deck 24 moves to the shifted position and then back the aligned position both during the return of the sliding deck 22). The critical element of forming the improved joint is the relative movement of the mating edges or faces of the belt ends when at least partially molten; thus, one of the decks, such as the shifting deck 24, necessarily shifts when the belt ends are in contact. The other movement of the decks 22, 24 may be selected for a desired configuration of the belt splicer 10, ease of manufacturing, etc. Additionally, it is not necessary that the decks 22, 24 are actually aligned in the aligned position; it is only imperative that at least one of the decks shifts relative to the other deck, regardless of whether the decks 22, 24 are initially aligned. As another alternative, one of the decks may remain stationary while the other deck undergoes both the sliding and shifting movement. In one alternative, both of the decks may shift rather than just one of the decks shifting. Additionally, the heating element positioner 70 need not be coupled to the sliding deck 22 for cooperative movement in the transverse direction; the positioner 70 can be linked to another component of the belt splicer 10 or may be completely independently movable.

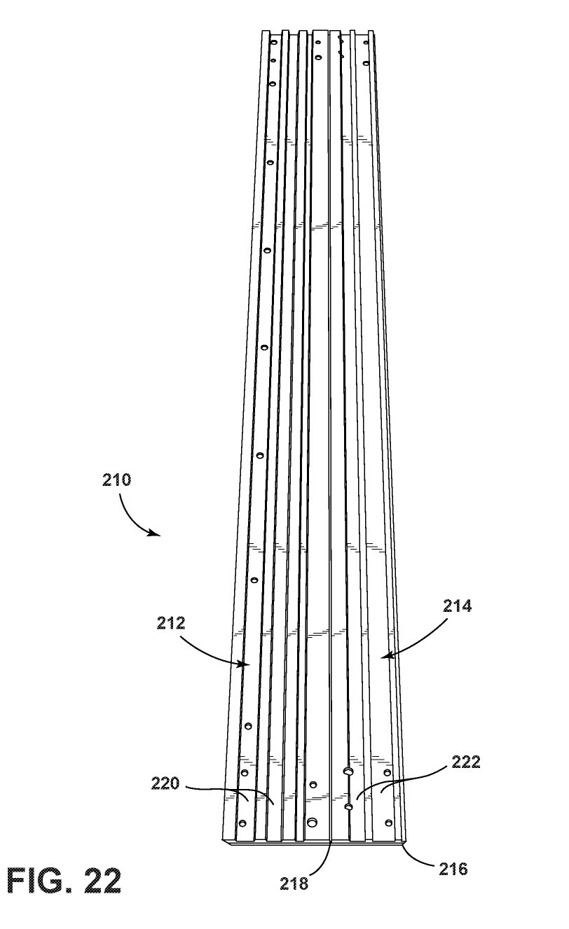

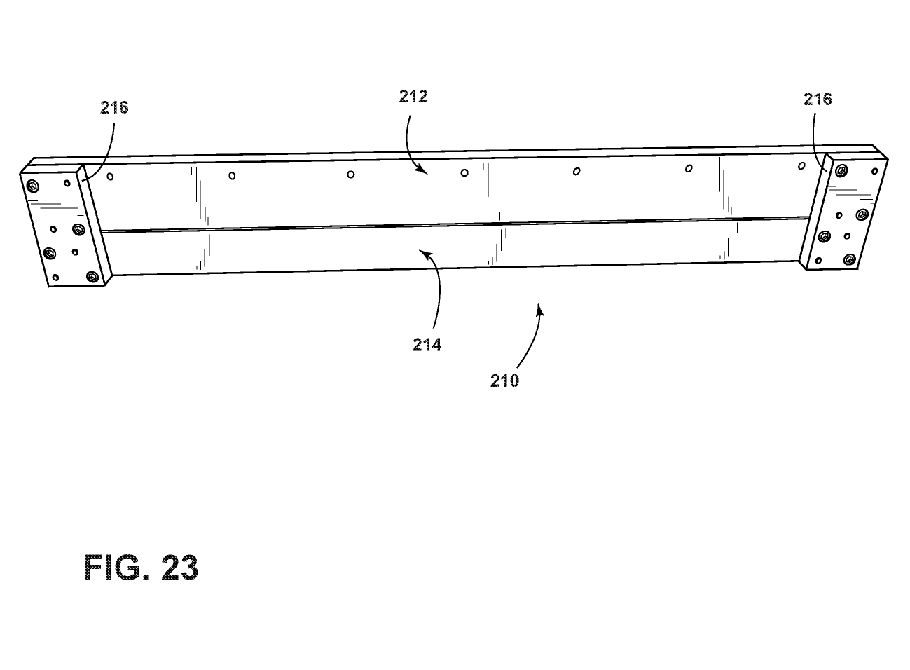

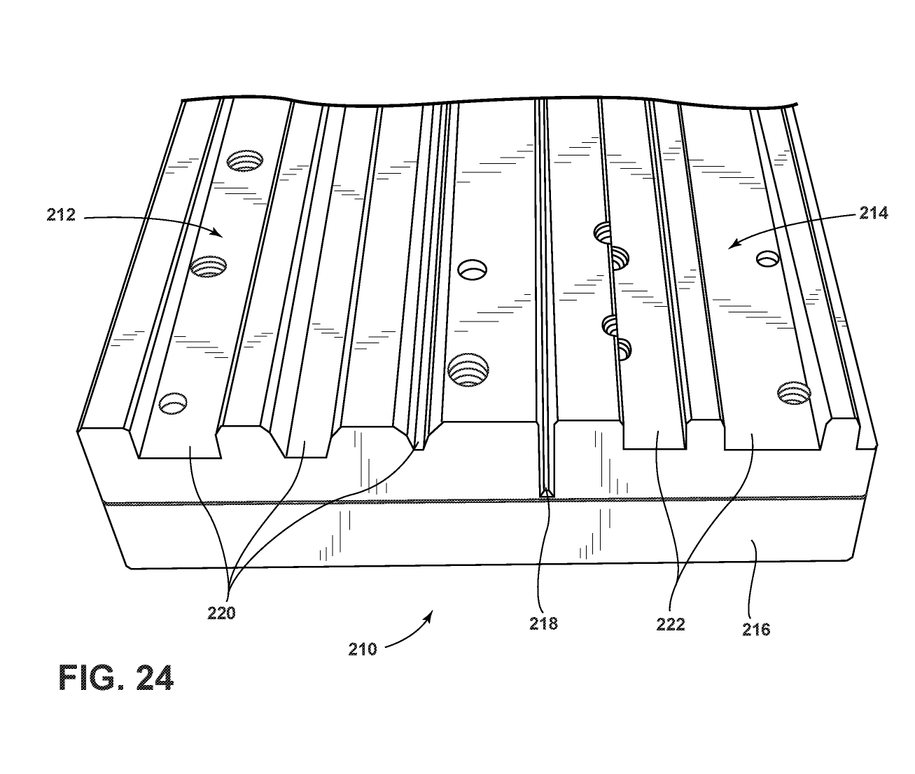

Referring now to FIG. 22, a belt end can be trimmed in preparation for splicing with a belt trimming jig 210 that holds the belt ends in place during trimming. While the trimming of the belt may occur at any location on the belt, the illustrated belt trimming jig 210 is configured for trimming of the belt in a direction transverse to its longitudinal axis. The exemplary embodiment of the jig 210 includes a first, elongated trimming deck 212 and a second, elongated trimming deck 214 mounted adjacent to one another in juxtaposition by a pair of supports 216, one mounted at each end of the jig 210 below the decks 212, 214 and transversely spanning the decks 212, 214, as best seen in FIG. 23. Referring now to the enlarged view of one end of the jig 210 in FIG. 24, the decks 212, 214 are in abutting contact along respective elongated side edges, thus forming an interface 218. In the illustrated exemplary embodiment, the first deck 212 is wider than the second deck 214 and includes three grooves 220 formed in the upper surface of the deck 212 parallel to the longitudinal axis of the deck 212. Similarly, the second deck 214 includes two grooves 22 formed in the upper surface of the deck 214 parallel to the longitudinal axis of the deck 214. The grooves are configured to receive teeth located on the bottom surface of a belt (not shown). In operation, a user places a belt end on the jig 210 with the teeth inserted into the grooves 220, 222 and employs a trimming tool (not shown), such as a razor blade or other knife-like structure, to cut the belt end along the interface 218 between the decks 212, 214. The trimming tool may pass through the belt and enter the space between the decks 212, 214 at the interface 218 while the belt remains in position with its teeth in the grooves 220, 222. The user may apply downward force onto the belt to help retain the belt in the jig 210 during the trimming process. The jig 210 may be modified as needed to accommodate different configurations of belts, including belts without teeth, and different configurations of belt teeth. Further, the jig 210 may include an assembly to apply the downward force to the belt rather than the user manually applying the force.

To the extent not already described, the different features and structures of the various embodiments may be used in combination with each other as desired. That one feature may not be illustrated in all of the embodiments is not mean to be construed that it cannot be, but is done for brevity of description. Thus, the various features of the different embodiments may be mixed and matched as desired to form new embodiments, whether or not the new embodiments are expressly described. As well is it will be understood that various modifications can be implemented and not depart form the scope of the invention. For example, the belt splicer may be adapted for use with flat belts or toothed belts, and one or more portions of the described process of using the belt splicer may be automated.

While the invention has been specifically described in connection with certain specific embodiments thereof, it is to be understood that this is by way of illustration and not of limitation, and the scope of the appended claims should be construed as broadly as the prior art will permit.

For example, it will be understood that the belt splicer can be automated wherein elements such as a controller with associated memory and software will automatically control the timing and sequence of the respective sliding and shifting movements as well as the heating element. It may be that one deck is configured to do both the sliding and shifting movement, and the other deck is stationary.

1. A belt splicer for splicing two ends of at least one thermoplastic belt together, comprising:
a first elongated deck configured to hold a first end of at least one thermoplastic belt;
a second elongated deck configured to hold a second end of the at least one thermoplastic belt in the same plane as the first end, the first and second elongated decks having parallel longitudinal axes;
a sliding assembly coupled to at least one of the first and second elongated decks to urge the at least one of the first and second elongated decks to move in a sliding direction normal to the longitudinal axes;
a shifting assembly coupled to the at least one of the first and second elongated decks to urge the at least one of the first and second elongated decks to move in a shifting direction parallel to the longitudinal axes; and
a heating element disposed to heat the first and second ends to a melt temperature;
wherein the sliding assembly and the shifting assembly move the at least one of the first and second elongated decks in the sliding and shifting directions to splice the first and second ends together after the first and second ends are heated to the melt temperature.

2. The belt splicer of claim 1 further comprising a first clamping assembly 28 to clamp the first end to the first elongated deck and a second clamping assembly (28) to clamp the second end to the second elongated deck.

3. The belt splicer of claim 1 wherein the sliding assembly is coupled to the first elongated deck and the shifting assembly is coupled to the second elongated deck.

4. The belt splicer of claim 1 wherein the sliding assembly and the shifting assembly are linked to each other to move the at least one of the first and second elongated decks in a sequence.

5. The belt splicer of claim 4 wherein the sequence is that movement in the shifting direction occurs after movement in the sliding direction.

6. The belt splicer of claim 1 further comprising at least one biasing element to bias the movement in the sliding and shifting directions.

7. The belt splicer of claim 1 further comprising a heating element positioner disposed to move the heating element toward and away from a position between the first and second ends.

8. The belt splicer of claim 1 wherein the first and second elongated decks have at least one groove to accommodate teeth on the at least one thermoplastic belt.

9. A method of splicing two ends of at least one thermoplastic belt together, comprising:
positioning a first end of at least one thermoplastic belt spaced apart from a second end of the at least one thermoplastic belt in the same plane as the first end;
heating the first and second ends to a softened state;
sliding at least one of the first and second ends toward the other of the first and second ends in a transverse direction; and
shifting the at least one of the first and second ends in a longitudinal direction normal to the transverse direction as the first and second ends meet while the first and second ends are in the softened state.

10. The method of claim 9 further comprising moving a heating element into a position between the first and second ends.
